(19) United States
(12) Patent Application Publication
(10) Pub. No.: US 2005/0008427 A1
(43) Pub. Date: Jan. 13, 2005

(54) Fastening system

(76) Inventors: Herbert Huber, Vilsheim (DE); Joachim Schneider, Ehringshausen (DE); Franz Pfundtner, Steinach (DE); Frank Drexler, Ortenberg (DE)

Correspondence Address: HARNESS, DICKEY & PIERCE, P.L.C., P.O. BOX 828, BLOOMFIELD HILLS, MI, 48303, US

(21) Appl. No.: 10/850,565

(22) Filed: May 13, 2004

Related U.S. Application Data
(63) Continuation of application No. PCT/EP02/12468, filed on Nov. 8, 2002.

(30) Foreign Application Priority Data
Nov. 13, 2001 (DE) DE 101 56 403.1

(51) Int. Cl. F16B 1/00; F16P 5/00

(52) U.S. Cl. 403/2

(57) ABSTRACT

A fastening system is providing, the fastening system has a weld stud welded to a sheet metal surface at a weldment portion to form a weld joint. The system additionally has a fracturable nut coupled to the weld stud. The fracturable nut and stud construction is configured to fail under torsional load prior to the failure of the sheet metal or the weld joint.

### CROSS-REFERENCE TO RELATED APPLICATIONS

This application is a continuation of PCT International Application PCT/EP02/12468 filed on Nov. 8, 2002, which claims the benefit of German Application DE 101 56 403.1, filed Nov. 13, 2001. The disclosure of the above applications is incorporated herein by reference.

### BACKGROUND AND SUMMARY

The present invention relates to a fastening system for fastening a member to a structural metal part, in particular for fastening a member to sheet metal, such as the sheet metal of the body of a motor vehicle, with a threaded metal stud that is fastened to the structural part in short-time arc welding, and a lock nut that is screwed onto the stud and by which the member is fastened to the structural part. Such a fastening system is known from U.S. Pat. No. 5,579,986 A. The fastening system is frequently used in the automobile industry. It is used there chiefly to fasten elements of the interior fittings to the vehicle body.

The threaded stud is welded onto a metal sheet of the body in so-called short-time arc welding. Short-time arc welding is also known as stud welding. There a metal stud (threaded stud) is placed on the sheet metal of the body. A pilot current is then turned on and the metal stud is again slightly lifted off from the sheet metal of the body. At the same time, an arc is drawn. Then a welding current is turned on, so that the facing surfaces of metal stud and body sheet metal are fused. The metal stud is then again lowered onto the sheet metal of the body, so that the melts combine. The welding current is turned off and the whole fused mass solidifies.

A system for stud welding is disclosed in for example the brochure “Neue TUCKER Technologie. Bolzenschweissen mit System!” [New Tucker Technology. Stud Welding with System!], Emhard Tucker, September 1999. A lock nut is then screwed onto the stud, thus projecting from the sheet metal of the body. The nut acts to fix the member to the sheet metal. As a rule, the lock nut is made of synthetic material. The stud may be a coarse-pitch threaded stud or a fine-pitch threaded stud. A matching thread is provided on the lock nut. In the case of a coarse-pitch thread, it is alternatively possible that only one hole is provided on the lock nut. The coarse-pitch thread then cuts a corresponding counter-thread into the hole. Steel studs are welded onto conventional sheet steel. Aluminum studs are welded onto aluminum sheets or other aluminum carriers, recently also frequently used.

Stud welding is a high-tech process. Frequently, hundreds of such studs are used per vehicle. Individual welding operations are frequently performed by a robot. The total welding time may lie in the range of milliseconds per welding operation in this context. Like any other process, the stud welding process is also subject to failures. Uncovering these is the aim and object of routine quality control. In quality control, the studs are tested for strength. A torque or tension wrench is used for this purpose. Quality controls by torque or tension wrench occasionally find fractures in the stud and fractures of the sheet metal of the body in the region of the welded joint. The reasons for the failures may lie in faulty welded joints, but also in faulty lock nuts. In addition, it may also be that the torque or tension wrench was incorrectly adjusted. Fractures of threaded studs on the one hand and of metal body sheet on the other occur in undefined fashion. It is hard to establish what the reason for the failure was. In addition, reworking of the fractured sheet metal of a car body requires a considerably greater expenditure than reworking in the case of a fractured stud. In a fracture of the stud, a new stud can be welded at the same spot, without the strength of the sheet metal suffering.

The threaded stud known from U.S. Pat. No. 5,579,986 A mentioned at the beginning has between two threaded sections a weakened area that serves to remove an upper threaded section while a lower threaded section remains on the stud. It is also known, from DE 38 02 798 A1, to provide a stud with a predetermined breaking point wherein the strength of the predetermined breaking point is adapted to the metal sheets to be joined, and excessive deformation of the metal sheets is avoided. The predetermined breaking point is always used for removing the undesired shaft of the stud. Lastly, the document DE 100 04 720 C1 describes a device and a method for testing the attachment point of an externally threaded stud for torsional strength. In order to test the weld point for torsional strength, a driving member is chucked in a rotary driver by the clamping stud and the driver is set to a specified torque. Then a threaded part is screwed onto the external thread of the weld stud being tested. If its weld point does not withstand the specified torque, it separates.

Against this background, the problem underlying the invention is to indicate an improved fastening system of generic type, which in particular requires little reworking. This object is accomplished in the fastening system mentioned at the beginning in that the strength of the welded joint between the structural part and the threaded stud and the strength of the stud itself are adapted to one another so that, upon application of a torque that exceeds that torque which is applied per specification when the lock nut is screwed onto the threaded stud, it is ensured that the stud fractures before the structural part fractures.

According to another aspect, the above object is accomplished by the fastening system mentioned at the beginning in that the strength of the welded joint between the structural part and the threaded stud and the strength of the thread of the stud itself are adapted to one another so that, upon application of a torque that exceeds that torque which is applied per specification when the lock nut is screwed onto the threaded stud, it is ensured that the thread of the stud is damaged before the structural part fractures. This ensures that whenever too high a torque is applied to a threaded stud having a “good” welded joint, in every case the stud fractures or its thread is damaged, and not the structural part. In this way, reworking costs due to incorrectly adjusted torque or tension wrenches are reduced. Even when an incorrect (too strong a) lock nut is used, it is ensured that damage of the structural part is largely ruled out when the welded joint between the stud and the part is “good.”

In this connection, a “fracture” is intended to mean any damage to an element (lock nut, stud, structural part) in which a torque applied to the respective element can no longer be transmitted to a following element of the fastening chain. A fracture of the structural part generally is intended to signify that the part is structurally damaged, and in particular, that it pulls out in the region of the welded joint. In this way, the object is fully accomplished.

It is of special advantage when the threaded stud is weakened at one spot and when the weakening is designed so that the stud fractures at the point of weakening before the structural part fractures in the region of the welded joint between the structural part and the stud. This embodiment has the advantage that strengthening of the structural part (sheet metal of the body of the vehicle) is unnecessary to ensure that, upon application of an excessively high torque, the stud will fracture before the part fractures. There weakening may be effected in many ways, for example, by the selection of material, by the construction of the stud, etc. The case in which the thread of the stud becomes unusable, i.e., is no longer able to transmit torque, should also be understood as a fracture. Alternatively, by a fracture it is to be understood that the threaded stud as a whole breaks off against its foot, substantially without damaging the welded joint structurally.

It is of special advantage when the stud has a weakening recess, in particular a peripheral groove. Such a weakening recess makes it possible to ensure, in structurally simple fashion, that according to the invention first the stud fractures before the structural part fractures when an excessive torque is applied. The weakening recess may be produced by for example machining. A useful example embodiment of such a weakening recess is disclosed in GB 2 153 948 A, the disclosure of which is incorporated in the present application by reference.

According to another preferred embodiment, the threaded stud has a flange section that is arranged in the neighborhood of the welded joint and against which the member is screwed by the lock nut or against which the lock nut itself is screwed. This measure likewise contributes to the fact that, when too high a torque is applied, the stud in every case fractures in the region of the welded joint before the structural part fractures. This ensure that the tensile forces occurring when the lock nut is screwed on bear on the stud and not on the part. It is therefore possible to concentrate the weakening of the stud in such a way that weakening takes place with regard to the torque or the torsional force that is applied by the lock nut to the stud. At the same time, it is especially preferred when the weakened spot is arranged in the neighborhood of the flange section. In this way, weakening can be produced relatively easily in the region of the transition between flange section and the actual threaded section (shaft section). In the simplest case, weakening is already produced in that a relatively sharp-edged transition is provided from the actual threaded section to the flange section.

According to an additional preferred embodiment, the stud is a coarse-pitch threaded stud whose external thread, when the lock nut is screwed on, cuts a thread into its hole. According to an alternative embodiment, the threaded stud has a fine-pitch thread such as a metric thread and the lock nut has a corresponding internal thread. In addition, it is preferable when the strength of the threaded stud and the strength of the lock nut are adapted to one another in such a way that, upon application of a torque to the lock nut that exceeds that torque which per specification is applied when the lock nut is screwed onto the threaded stud, it is ensured that the lock nut is structurally damaged before the stud is structurally damaged. As a rule, the lock nut is made of synthetic material and is an element that is comparatively inexpensive to produce. In this respect, it is of special advantage when, upon application of too high a torque, in every case the nut breaks before the stud breaks or its function is adversely affected in any way.

On the whole, in this way a closed process chain is obtained in which the predetermined breaking moment of the lock nut is smaller than the pre-determined breaking moment of the threaded stud, which in turn is smaller than the predetermined breaking moment of the structural part and/or of the welded joint between the structural part and the stud. It goes without saying that the features mentioned above and to be explained below are usable not only in the combination indicated in each instance, but are also usable in other combinations or standing alone, without exceeding the scope of the present invention.

### BRIEF DESCRIPTION OF THE DRAWINGS

Examples of the invention are represented in the drawing and are described in detail in the following description. Shown in

FIG. 1 is a schematic sectional view of a first embodiment of a fastening system according to the invention;

FIG. 2, a detailed view of a modified embodiment of a fastening system, in section;

FIG. 3, a sectional representation of an additional embodiment of a fastening system according to the invention; and

FIG. 4, a diagram with a qualitative representation of a variety of relevant torques of the fastening system of the present invention.

### DETAILED DESCRIPTION OF THE PREFERRED EMBODIMENTS

In FIG. 1, a first embodiment of a fastening system of the present invention is labeled generally 10. The fastening system 10 acts to fasten a member 12, in the case represented a part of synthetic material traversed by an aperture 13, to a structural part 14, in the present case the sheet metal 14 of a car body. The fastening system 10 includes a threaded stud 16, which is welded onto the sheet metal 16 [sic; should be: 14] of the car body in the stud welding process. In addition, the fastening system 10 contains a lock nut 18 made of synthetic material, which is capable of being screwed onto the stud 16. The stud 16 contains a flange section 20. In the present case, a flange section is intended to mean a section with a fairly great diameter that is at least twice as great as the shaft section of the stud. The threaded stud 16 is welded in the stud welding process by the underside of its flange section 20 onto an upper side of the car body sheet metal 14. The welded joint 22 is shown schematically in FIG. 1. On the opposing side of the flange section 20 there is provided a shaft section 24, on which is formed a coarse-pitch thread 26.

In the region of the transition between the coarse-pitch thread 26 and the flange section 20, the threaded stud 16 in addition has a weakened section 28, which in the present case is formed by a peripheral groove 30. The peripheral groove 30 represents a predetermined breaking point of the stud, as will be explained below in detail. The lock nut 18 has a hole 32 and the diameter of the hole 32 is adapted to the diameter of the shaft section 24. The coarse-pitch thread 26 is designed as a self-cutting thread and therefore an internal thread is cut into the hole 32 when the lock nut 18 is screwed onto the stud 16. As can be seen in FIG. 1, the aperture 13 of the member 12 is slipped onto the threaded stud 16. Then the lock nut 18 is screwed on, so that the member 12 is held between the upper side of the flange section 20 and the lower side of the lock nut 18. In FIG. 1, it is indicated schematically how a torque M applied to the lock nut 18 is converted in the region of the thread 26 into an axial force A, which produces a tensile force on the stud 16, and into a tangential force T, which in turn exerts a corresponding moment on the threaded stud 16.

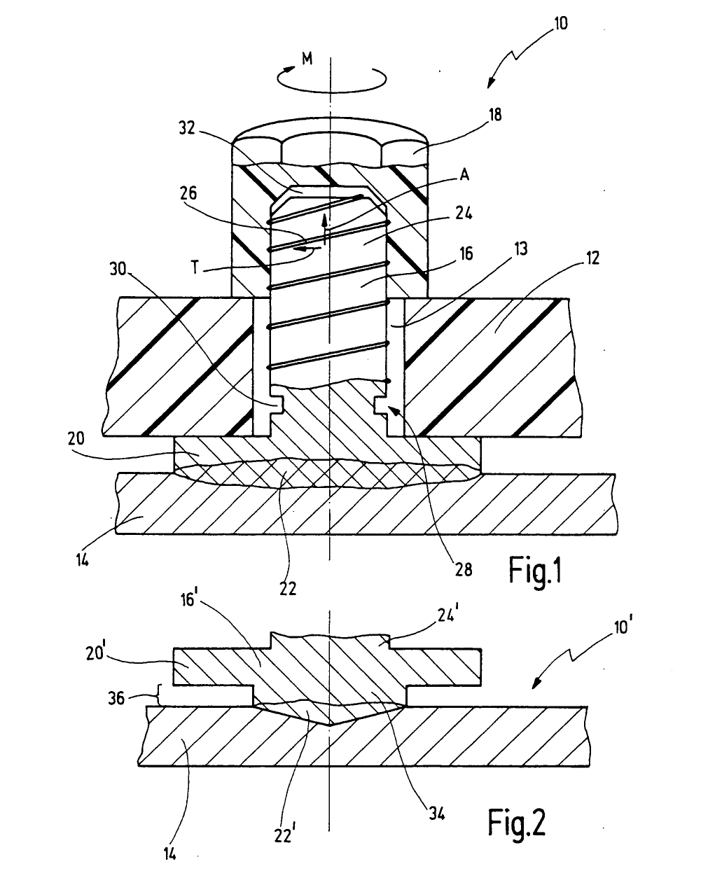

A modification 10′ of the fastening system 10 is shown in FIG. 2. In the fastening system 10, the threaded stud 16′ is designed with a flange section 20′, which lies between a shaft section 24′ and a welded section 34. When a threaded stud 16′ is welded onto the sheet metal of a car body 14, a welded joint 22′ is produced between the welded section 34 and the sheet metal 14. Therefore, a space 36 remains between the upper side of the sheet metal 14 and the underside of the flange section 20′. The diameter of the welded section 34 is selected greater than the diameter of the shaft section 24′. On the whole, therefore, a welded joint 22′ can be obtained with a strength that is greater than that strength which is obtainable when the diameter of the welded section 34 is equal to the—specified—diameter of the shaft section 24′. Owing to the space 36, back ventilation is obtained, so that corrosion problems are avoided. Otherwise, the fastening system 10′ does not differ from the fastening system 10, so that reference is made to the description of the latter.

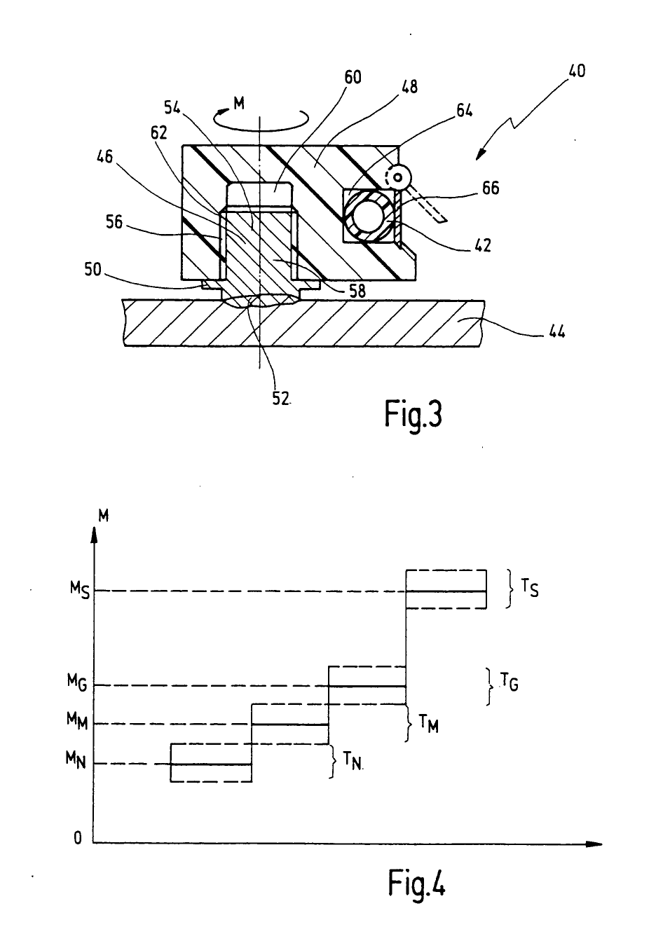

FIG. 3 shows an additional embodiment of a fastening system 40.

The fastening system 40 acts to fasten a member 42 in the form of a metal tube to a structural part 44, such as the sheet metal of a car body.

The fastening system 40 has a threaded stud 46, which is welded by a stud-welding process to the sheet metal 44 of a car body. In addition, the fastening system 40 includes a lock nut 48 in the form of a clip of synthetic material. The threaded stud 46 has a flange section 50, which corresponds to the flange section 20′ of the fastening system 10′ of FIG. 2. A welded joint between the threaded stud 46 and the sheet metal 14 of a car body is shown at 52. A shaft section 54 of the stud 46 is provided with a metric thread 56.

The threaded stud 46 is weakened in the region of the transition between the shaft section 54 and the flange section 50, as is shown schematically at 58. In the fastening system 40, weakening is effected only in that the diameter of the shaft section 54 is distinctly smaller than the diameter of the flange section 50 and a welded section lying under the latter and not described in detail. In addition, the transition between the shaft section 54 and the flange section 50 is designed as a sharp-edged corner. The lock nut 48 has a hole 60, which is provided with an internal metric thread 62. Therefore, the lock nut 48 (the clip of synthetic material) can be screwed onto the threaded stud 46. In the present case, the clip of synthetic material is screwed onto the threaded stud 46 until an underside of the clip 48 strikes an upper side of the flange section 50. The member 42, in the form of a metal tube, is fixed exclusively to the clip 48 of synthetic material. In the embodiment shown, a recess 64 is provided for the accommodation of the metal tube 42. In addition, the clip 48 of synthetic material has a flexibly seated locking strap 66, which is designed for the purpose of closing off the recess 64 and so accommodating the metal tube 42 form-lockingly in the clip 48.

It is understood that in all three embodiments of FIGS. 1 to 3, the threaded studs 16, 46 and the sheet metal 14, 44 of a car body may in each instance consist of steel or a steel alloy or of aluminum or an aluminum alloy. It is also understood that the lock nuts 18, 48 may be made of a material other than synthetic material, provided that the strength requirements explained below with reference to FIG. 4 are met. The member 12 may alternatively be a metal element. Correspondingly, the member 42 may alternatively be an element of synthetic material. In all three embodiments, the strengths of the separate elements are adapted to one another, as is shown schematically in FIG. 4.

A torque M, which in the representation of FIG. 1 is applied to the lock nut 18 in order to fasten the member 12 to the sheet metal of a car body, is plotted on the abscissa in FIG. 4. In order to obtain proper fastening of the member 12, the lock nut 18 is screwed on with a given rated torque M_{N}, which in FIG. 4 is represented qualitatively as greater than zero. The rated torque M_{N} is assigned a tolerance region T_{N}, within which the rated torque M_{N} typically applied by a torque wrench or tension wrench varies. Upon application of the rated torque M_{N}, assuming failure-free parts and a failure-free welded joint 22, proper fastening of the member 14 is obtained. A predetermined breaking moment of the lock nut 18 is additionally shown at M_{M} in FIG. 4. The predetermined breaking moment M_{M} is qualitatively higher than the rated torque M_{N}. The predetermined breaking moment M_{M} is assigned a tolerance region T_{M}, within which the lock nut 18 fractures or its thread is destroyed. At the same time, care should be taken to see that the tolerance regions T_{M} and T_{N} do not intersect, but preferably adjoin one another. FIG. 4 additionally shows a predetermined breaking moment M_{G} of the threaded stud 16. The predetermined breaking moment M_{G} is qualitatively higher than the predetermined breaking moment M_{M} of the lock nut 18. The pre-determined breaking moment M_{G} is assigned a tolerance region that does not intersect with the tolerance region T_{M} of the lock nut 18, but directly adjoins it.

Lastly, a predetermined breaking moment of the welded joint 22 is shown at M_{S} in FIG. 4. The predetermined breaking moment M_{S} is distinctly greater than the predetermined breaking moment M_{G} of the stud 16. The predetermined breaking moment M_{S} of the welded joint 22 is likewise assigned a tolerance region T_{S}. The tolerance region T_{S} of the predetermined breaking moment M_{S} of the welded joint 22 does not intersect with the tolerance region T_{G} but, rather, lies at a considerable distance apart from it. It is therefore ensured that the maximum predetermined breaking moment M_{G} still capable of being borne by a threaded stud (the upper limit of the tolerance region T_{G}) is distinctly smaller than the minimum predetermined breaking moment M_{S}, at which the welded joint 22 could fracture. For purposes of simple representation, only one fracture of the welded joint 22 has been mentioned regarding FIG. 4. However, it is understood that this is intended to mean a fracture of the welded joint and/or of the sheet metal of a car body.

This “closed process and fastening chain” of rated torque and pre-determined breaking moments ensures that, in every operating condition, the element whose replacement results in the lowest costs is always the one that fractures. If, when the lock nut 18 is screwed onto the member 12, too high a torque M (greater than the upper limit of the tolerance region T_{N}) is inadvertently applied, the nut fractures or its thread strips in every case, since the pre-determined breaking moment M_{M} of the nut is distinctly smaller than the predetermined breaking moment M_{G} of the threaded stud 16, and because of the fact that the tolerance regions T_{M} and T_{G} do not intersect. If, in the representation of FIG. 1, an incorrect lock nut 18 (a lock nut with too high a strength) has inadvertently been selected, the distinct distance apart of the tolerance regions T_{G} and T_{M} in every case ensures that first the stud 16 fractures (usually at its predetermined breaking point 30 or by destruction of its thread), and therefore no damage to the welded joint 22 or to the sheet metal 14 of the car body occurs. For all sources of error that may occur in the fastening system 10, it is therefore ensured that the welded joint 22 and the sheet metal 14 of the car body are not unnecessarily damaged.

In quality control of the threaded stud before the lock nut 18 is screwed on, a test moment that is equal to the predetermined breaking moment M_{M} of the specified lock nut 18 is usually applied to the stud. A fiberglass-reinforced test nut is usually used for this purpose. If, in this testing, too high a torque is inadvertently applied, the distance between the tolerance regions T_{G} and T_{S} ensures that in every case the stud 16 fractures and the welded joint 22 and the sheet metal 14 of the car body are not damaged. The above description of the various moments and the closed process chain is correspondingly applicable to the embodiments of FIGS. 2 and 3. In the case of the embodiment of FIG. 3, the clip 48 of synthetic material represents the lock nut. It is understood that the thread match between the studs 16, 46 and the lock nuts 18, 48 should be selected so that, in case of destruction of the thread of the lock nuts 18, 48, unscrewing should nevertheless be possible, so as to prevent unnecessarily high torques from being applied to the studs 16, 46 upon unscrewing. Because of the closed process chain, the lock nut 18, 48 (which usually is made of synthetic material) is the “weakest link.” The next weakest link is the fastening stud 16. The welded joint 22 or 52 has the greatest strength.

1-9. cancel.

10. A fastening system for fastening a member to a sheet metal structure comprising:
a weld fastener welded to the sheet metal structure to form a weld joint, the weld joint having a first torsional strength, the weld fastener having a second torsional strength, wherein the first torsional strength is greater than the second torsional strength.

11. A fastening system for fastening a member to a sheet metal structure comprising:
a weld fastener welded to the sheet metal structure to form a fastener to surface interface area having a first torsional strength, the fastener having a second torsional strength, wherein the first torsional strength is greater than the second torsional strength.

12. The system according to claim 11 wherein the weld fastener is a threaded stud.

13. The system according to claim 12 wherein the weld fastener defines a first region having a first fastener torsional strength and a second portion having a second fastener torsional strength.

14. The system according to claim 12 wherein the first region defines a weakened recess.

15. The system according to claim 14 wherein the weld fastener comprises a mounting flange and wherein the weakened recess is located adjacent the mounting flange.

16. The fastener according to claim 11 wherein the weld fastener comprises a mounting flange, said mounting flange having a member bearing surface and a weld surface.

17. The system according to claim 11 wherein the weld fastener comprises a coarse pitch thread cutting stud.

18. The system according to claim 11 wherein the weld fastener comprises a fine thread.

19. The system according to claim 11 further comprising a nut, said nut having a nut torsional strength which is less than the second torsional strength.

20. The system according to claim 19 wherein the nut is configured to be rotatably coupled to the weld fastener with the application of a first torque load.

21. The system according to claim 19 wherein the nut is configured to fail when subjected to a torque load is greater than a first torsional load.

22. The system according to claim 19 wherein the nut fractures when subjected to loads greater than the first torque load.

23. The system according to claim 19 wherein the nut comprises threads which fail when the nut is subjected to loads greater than the first torque load.

24. An automotive vehicle apparatus comprising:
a sheet metal panel;
a threaded fastener welded to the panel at a weld joint, wherein said weld joint has a first torsional strength and said fastener has a second torsional strength, wherein the first torsional strength is greater than the second torsional strength.

25. The apparatus according to claim 24 wherein the fastener comprises a longitudinally elongated shaft, and a laterally enlarged head extending from an end of the shaft.

26. The apparatus according to claim 25 wherein the longitudinally elongated shaft defines a groove.

27. The apparatus according to claim 26 further comprising a second fastener configured to be coupled to the threaded fastener, said second fastener having a third torsional strength which is less than the second torsional strength.

28. The apparatus according to claim 24 wherein the first fastener is configured to fail in a manner in which torque above a first torque level applied to the fastener is not transmitted to the sheet metal panel.

29. The apparatus according to claim 27 wherein the second fastener is configured to fail in a manner in which the torque above a second torque level is not transmitted to the sheet metal panel.

30. The apparatus according to claim 27 wherein the second fastener is configured to fail in a manner in which the torque above a second torque level is not transmitted to the first fastener.

31. The apparatus according to claim 27 wherein the second fastener is a synthetic nut.

32. The apparatus according to claim 24 wherein the sheet metal panel comprises steel.

33. A fastening system for fastening a member to a sheet metal structure comprising:
a sheet metal panel, said panel configured to fail once subjected to a first moment;
a threaded fastener configured to fail when subjected to a second moment, said threaded fastener being welded to the sheet metal panel to form a weld joint, said weld joint configured to fail once subjected to a third moment; and
a second fastener configured to be coupled to the threaded fastener, said second fastener configured to fail when subjected to a fourth moment, wherein the first moment is greater than the second moment.

34. The system according to claim 33 wherein the fourth moment is greater than the third moment.

35. The system according to claim 34 wherein the third moment is greater than the second moment.
